(19) United States
(12) Patent Application Publication
(10) Pub. No.: US 2020/0000287 A1
(43) Pub. Date: Jan. 2, 2020

(54) Heat Diverting Pot Handle

(71) Applicant: E. MISHAN & SONS, INC., NEW YORK, NY (US)

(72) Inventor: Wood Yik Paul Lam, Hong Kong (CN)

(73) Assignee: E. MISHAN & SONS, INC., NEW YORK, NY (US)

(21) Appl. No.: 16/208,889

(22) Filed: Dec. 4, 2018

(30) Foreign Application Priority Data
Jun. 28, 2018 (CN) 201821008522.6

(51) Int. Cl. A47J 45/08; A47J 45/06

(52) U.S. Cl. CPC A47J 45/08; A47J 45/061

(57) ABSTRACT

A heat diverting pot handle for engagement to a cooking pot. The pot handle engages with the cooking pot at a first end through the engagement of two forks extending at angles from the first end to engagements with the pot body. An opening between the two forks provides a passage for heat generated from a heat source against the bottom surface of the pot body through the handle to keep the handle cool. Skirts extending from lower surfaces of the two forks are positioned to contact the upper edge of a lower positioned pot body when stacked to prevent scratches in the cooking surface of the lower-positioned pot body.

### FIELD OF THE INVENTION

The device herein relates generally to cooking pots employed over a burner. More particularly, it relates to a pot handle in an engagement with a cooking pot which is configured to divert burner heat in a manner to minimize handle heating.

### BACKGROUND OF THE INVENTION

In the current field of cooking technology, conventional cooking pots employed to heat food while positioned over a heat source generally includes a pot body engaged to an extending handle. In order to reduce the weight of the pot, conventional handles have been configured to employ a hollow handle structure. Such handle structures conventionally are shaped to also allow user friendliness during use in cooking.

Conventional cooking pots are frequently configured with a handle formed of stainless steel or of other metallic materials which are similar in nature. Due to the thermal conductivity of such handle materials, during the act of cooking which creates a very hot pot from the heat source, the heat from the pot will transfer to the material forming the handle.

In the absence of heat-proof gloves, hand contact with the heated handle will cause potentially severe burns to the user from the heat of conventional handles which lack a configuration adapted to dissipate the build up of heat in the handle from the connected pot.

In addition, conventional cooking pots formed of metal with engaged metal handles such as those formed of stainless steel handle and the like, due to the hardness of such material and metallic sharp edges, will cause damage to adjacent pots when they are stacked on top of one another. This will easily scrape the interior or edge of the pot in the bottom thereby damaging it and rendering it less effective for cooking.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The technical problem to be solved by the device herein is that, in view of the shortcomings of the existing technology, it provides a heat diverting pot which is configured with an opening forming a flu to accelerate heated air therethrough and hinder the conduction of heat to the handle and thus prevent the hand of a user from being burnt.

The device disclosed and described herein features a configuration rendering it to a heat diverting type pot. As shown herein, the disclosed device preferably includes a metallic pot body having a bottom surface adapted for placement above a heat source and a top surface configured to hold food which is cooked when the pot body is heated by the heat source.

Operatively connected to the pot body is a hollow handle. The connecting end or front end of the handle is formed with two forks extending therefrom. Each of the two forks at the connecting end of the handle is in a fixed connection with the pot body respectively. An opening is formed between the exterior of the pot body and an area in between the two forks and a portion of the handle between the forks. The connection of the front end of the handle with the pot body forms a retaining plate.

A solid planar plate or baffle is located between the two forks at an end of the handle positioned therebetween and faces the opening. This baffle extends downward from a first end adjacent a top surface of the handle which is closest to the bottom surface of the handle at an oblique angle which is currently substantially perpendicular to the bottom planar surface of the pot body. By substantially is meant plus or minus ten degrees.

In the above pot, a flu or exhaust passage for heat is formed through the opening which is surrounded by the baffle shielding the hollow portion of the handle, the exterior of the body of the pot, and the interior edges of the two forks. As a result, when the pot body is heated, heated air flows around the exterior of the body of the pot, and instead of continuously contacting the handle at a connection with the pot body, the heated air flows through the opening. This results in much less heat being conducted to the handle than if it were solid and heated air constantly contacted it. Further, because the air above the opening is cooler than the heated air entering the opening at the bottom of the handle, the air accelerates through the opening. Effectively, this prevents heat conduction to the handle which would be significantly hotter if there was not an opening and the handle was solid all the way to a connection with the pot body. This configuration also prevents the hand of a user from being scalded during use and not only improves the safety of use but also has a better user experience. A more detailed description of the utility model is provided below in conjunction with the drawings and embodiments.

Before explaining at least one preferred embodiment of the herein disclosed invention in detail, it is to be understood that the cooking pot invention is not limited in its application to the details of construction and to the arrangement of the components in the following description or illustrated in the drawings. The heat diverting pot herein described and disclosed in the various modes and combinations is also capable of other embodiments and of being practiced and carried out in various ways which will be obvious to those skilled in the art. Any such alternative configuration as would occur to those skilled in the art is considered within the scope of this patent. Also, it is to be understood that the phraseology and terminology employed herein are for the purpose of description and should not be regarded as limiting.

### BRIEF DESCRIPTION OF THE DRAWING FIGURES

FIG. 1 is a stereo diagram of a lower view of the pot body showing a bottom surface of the pot body and the configuration of the connection of the handle to the pot within marked area A.

FIG. 2 is a magnified image of area A in FIG. 1 showing the opening surrounded by the exterior surface of the pot body a baffle and skirts formed on each of two forks extending from the handle to engagements with the pot body.

FIG. 3 is a schematic diagram of the heat flow of the device in the process of using the pot showing a flu formed by the opening where heated air accelerates therethrough.

FIG. 4 shows the skirts on the two forks providing a lateral structure for two adjacent pots when stacked.

### DETAILED DESCRIPTION OF THE INVENTION

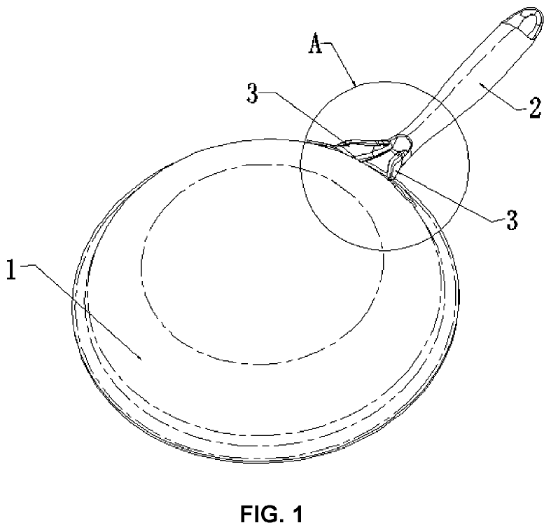

The utility model device disclosed herein is configured as a heat diverting type pot, which is shown in the combined drawings of FIG. 1 to FIG. 3. The device comprises a pot body 1 which is engaged to a hollow handle 2. The first end or front end of the handle 2 is formed with two forks 3 extending in a “Y” shape therefrom. The two forks 3 extending from the handle 2 on one end and are in a respective fixed connection to the pot body 1 at opposite ends. An opening 4 is thereby formed between the pot body 1 and the two forks 3 extending from the handle 2.

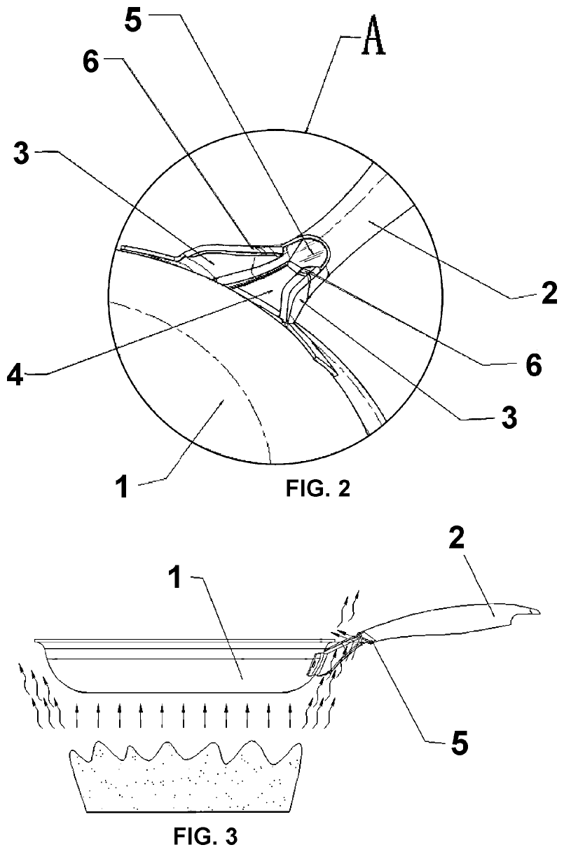

As seen more clearly in FIG. 2, at the front end of the hollow handle 2, blocking air access into the interior of the hollow handle 2, there is positioned a baffle 5 which is adjacent to the opening 4 and in between the two forks 3. Currently, the baffle 5 is at an oblique angle which is substantially perpendicular to the flat bottom surface of the pot body. However it may also be angled relative to the bottom surface to form a ramp directing heated air toward the opening. The handle 2, the two forks 3, and the baffle 5 can be welded, adhered, formed by integrated molding thereof, or formed in other modes as would occur to those in the art.

Also shown in FIG. 2 and depicted in operation in FIG. 3, the opening 4 formed between the pot body 1 and the two forks 3 and the baffle 5 at the junction point of the two forks 3 with the handle 2, defines a flu or passage for heated air therethrough which would otherwise contact the bottom of the handle to the pot body 1 for a much longer duration of time. Consequently, when the pot body 1 is heated by a heat source such as in FIG. 3, the heated air accelerates and flows around the pot body 1, and instead of forming an ongoing contact with the bottom of the handle 2 adjacent to the pot body 1, the heated air flows upward through the opening 4. Concurrently, the baffle 5 reflects heated air which would otherwise enter the hollow handle, back upward and through the opening 4. This configuration effectively hinders the conduction of heat from the rising heated air to the hollow handle 2, and thereby effectively prevents the hand of a user from being burnt during use. Furthermore, this configuration not only improves the safety of use, but also provides a cooler handle to the user for a better cooking experience.

In the device shown in FIGS. 1-4, the front end of the two forks 3 surrounding two sides of the opening 4, form the connection or first end of the handle 2 in a forked “Y” shaped structure. In a particularly preferred mode of the device herein, in order to better block the heat from entering the hollow handle and heating it, as shown in FIG. 2 and FIG. 3, the baffle 5 tilts or angles below the top of the handle 2 in an oblique angle. This angle between the baffle 5 and the handle 2 is preferably a sharp angle.

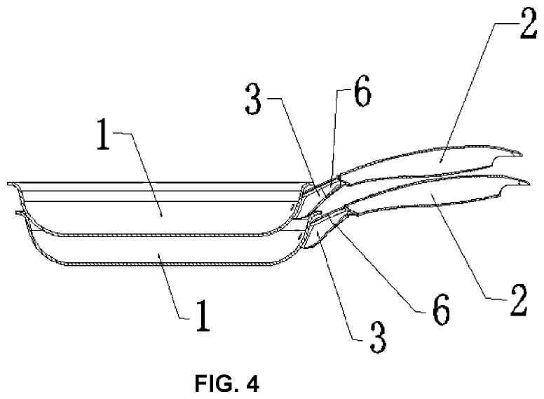

Also in a particularly preferred mode of the device herein, connecting ends of each of the two forks are permanently engaged to the pot body 1 such as by riveting. Further preferred in a particularly preferred mode is the inclusion of a skirt edge 6 along both bottom edges of both of the two forks 3. As shown in FIG. 4, this skirted edge 6 forms a wider bottom edge of each fork 3, extending to the exterior surface of the pot body 1. The skirted edge 6 is shaped to contact the upper edge of a pot body 1 situated below the two skirted edges on a first side of a lower situated pot and to cause to opposite side of the pot body 1 from that on which the handle 2 and skirted edges 6 are located, to contact the upper edge of the lower situated pot body 1. This opposing contact prevents the bottom surface of the upper situated pot body 1 from contacting the cooking or upper surface of the lower situated pot body 1 in a stack as shown in FIG. 4. This positioning, by preventing the lower surface of the upper situated pot body 1 from contact with the cooking surface of a lower situated pot body 1, prevents scratches from occurring on the cooking surface of the lower pot body 1 thereby protecting any coating thereon from such scratches and abrasions which could inhibit future cooking thereon.

While the present invention has been described herein with reference to particular embodiments thereof, various changes and substitutions are intended in the foregoing disclosures and it will be appreciated that in some instance some features of the invention could be substituted by those skilled in the art and other configurations of the invention could be employed without departing from the scope of the invention as set forth in the following claims. All such modifications or substitutions or configurations are considered to be within the scope of this invention.

What is claimed is:

1. A heat diverting pot handle comprising:
a pot handle having a first end opposite a distal end;
the pot handle having an upper surface and a lower surface;
the pot handle being hollow;
two forks extending from the first end of the handle;
the two forks extending from the first end of the handle at opposing angles to respective second ends of the forks in fixed engagements with a body of a pot;
an opening positioned in between the two forks;
a baffle plate positioned on the first end of the handle;
the baffle plate extending from a first end thereof adjacent the upper surface of the handle to a second end thereof adjacent the lower surface of the handle;
located in between the two forks;
a flu located below the opening for directing heat from a heat source heating the pot body through the opening; and
the flu defined by an area between a surface of the baffle plate opposite an exterior surface of the pot body and facing surfaces of the two forks.

2. The heat diverting pot handle of claim 1, additionally comprising:
the two forks extending from the first end of the handle at opposing angles forming a “Y” shape.

3. The heat diverting pot handle of claim 1, additionally comprising:
an angle of said surface of said baffle plate relative to a planar bottom surface of the pot body being a sharp angle of substantially ninety degrees.

4. The heat diverting pot handle of claim 1, additionally comprising:
the fixed engagement of each of the forks to the pot body being a respective riveted engagement.

5. The heat diverting pot handle of claim 1, additionally comprising:
a skirt formed on lower surfaces of each of the two forks;
each skirt positionable to contact a top edge of a lower positioned pot body when the body of the pot in the engagement with the two forks herein, is stacked thereon; and
the contact of the skirt on each of the lower surfaces of the two forks preventing a contact of a lower surface of the body of the pot in the engagement with the two forks herein with a top cooking surface of the lower positioned pot body, whereby scratches in the top surface of the lower-positioned pot body are prevented.

6. The heat diverting pot handle of claim 1, additionally comprising:
the handle, the two forks, and the baffle are formed by integrated molding.
